(19) United States
(12) Patent Application Publication
(10) Pub. No.: US 2016/0156532 A1
(43) Pub. Date: Jun. 2, 2016

(54) SERVER SYSTEM FOR MONITORING WORKING INFORMATION

(71) Applicants: Inventec (Pudong) Technology Corporation, Shanghai (CN); INVENTEC CORPORATION, Taipei City (TW)

(72) Inventor: Wen Cheng HUANG, Taipei City (TW)

(21) Appl. No.: 14/675,057

(22) Filed: Mar. 31, 2015

(30) Foreign Application Priority Data
Nov. 27, 2014 (CN) 201410698193.2

(51) Int. Cl. H04L 12/26

(52) U.S. Cl. CPC H04L 43/0817

(57) ABSTRACT

A server system for monitoring working information includes a plurality of hard disks, a processing module and an expander. Each the hard disk having a first real-time working information is provided to transmit a first real-time information signal including the first real-time working information. The processing module having a second real-time working information is provided to transmit a second real-time information signal including the second real-time working information. The expander includes a firmware electrically connected to the hard disks and the processing module so as to store the first and second real-time working information. A monitor module electrically connected to the processing module is further provided to transmit a monitoring signal to the expander through the processing module to capture the first and second real-time working information stored in the firmware.

### BACKGROUND OF INVENTION

1. Field of the Invention

The invention relates to a server system for monitoring working information, and more particularly to the server system that utilizes a monitor module to capture real-time working information of a processing module and hard disks from an expander.

2. Description of the Prior Art

As the network technology progresses every day, various electronic products have become the necessaries in people's daily life. Among these electronic products, the server is definitely one of the important pieces for constructing the network. Generally speaking, refer to FIG. 1 for a typical server system in the art schematically shown in a block view. As shown, this conventional server system PA1 includes a monitor module PA11, a processing module PA12, an expander PA13 and a plurality of hard disks PA14 (one shown in the figure).

The monitor module PA11 can be an ordinary computer apparatus or an SCSI enclosure service (SES) module, and is a device for the user to monitor the states of the hard disks PA14. The processing module PA12 electrically coupled with the monitor module PA11 is usually a serial attached SCSI (SAS) expansion card or cartridge. The expander PA13 electrically coupled with the processing module PA12 is usually an SAS expander. The hard disks PA14 are electrically coupled individually with the expander PA13.

In the art, the conventional method for capturing the working information of the hard disks PA14 includes the following steps: (a) the monitor module PA11 being triggered to forward a monitoring signal S1 from the processing module PA12 to the expander PA13, and then (b) the expander PA13 transmitting the information of the hard disks PA14 from the processing module PA12 back to the monitor module PA11. In the aforesaid step (b), the captured working information of the processing module PA12 would be also fed back to the monitor module PA11. Obviously, such an information-capturing method cannot provide a satisfied efficiency, and also the capturing of information won't be complete.

In addition, different brands of the serial attached SCSI expansion cards and the SAS expanders are not compatible. For the software to perform the monitor module is not always compatible to each, hence inconvenience for the users is definitely inevitable.

### SUMMARY OF THE INVENTION

Accordingly, in order to resolve the less-efficiency and incompatibility among and caused by various brands of processing modules and the expansion cards for the server system, it is the primary object of the present invention to provide a server system for monitoring working information, in which an expander is used to store the real-time working information of the processing module and the hard disks, and then the monitor module can directly capture the real-time working information of the processing module and the hard disks from the expander.

In the present invention, the server system for monitoring working information includes hard disks, a processing module and an expander. Each the hard disk having a first real-time working information is provided to transmit a first real-time information signal including the first real-time working information. The processing module having a second real-time working information is provided to transmit a second real-time information signal including the second real-time working information. The expander includes a firmware electrically connected to the hard disks and the processing module so as to store the first and second real-time working information. A monitor module electrically connected to the processing module is further provided to transmit a monitoring signal to the expander through the processing module to capture the first and second real-time working information stored in the firmware.

In one embodiment of the present invention, the first real-time working information is at least one of a physical address information, a logical address information, a connection information and an access information. After the expander receives the first real-time working information, the first real-time working information is stored into the firmware so as to establish a hard disk information table, and the hard disk information table includes at least one correlation among the physical address information, the logical address information, the connection information and the access information. In addition, the processing module and the expander are electrically coupled through a serial attached SCSI (SAS) interface, and the second real-time working information is connection information of the processing module coupling electrically the expander via the serial attached SCSI (SAS) interface. The connection information can be a transmission rate. After the expander receives the second real-time working information, the second real-time working information is stored into the firmware so as to establish a processing module information table, and the processing module information table lists a corresponding relationship between a number of a transmission line and the connection information. Further, the monitor module is an SCSI enclosure service (SES) module.

By providing the server system for monitoring working information of the present invention, for the monitor module can be directly triggered to capture the real-time working information of the processing module and the hard disks stored in the expander, thus no more report of the working information from the processing module is required, and definitely the capturing efficiency of the information can be upgraded and the prior problem in incompatibility can be resolved.

All these objects are achieved by the server system for monitoring working information described below.

### BRIEF DESCRIPTION OF THE DRAWINGS

The present invention will now be specified with reference to its preferred embodiment illustrated in the drawings, in which:

FIG. 1 is a schematic block view of a typical server system in the art;

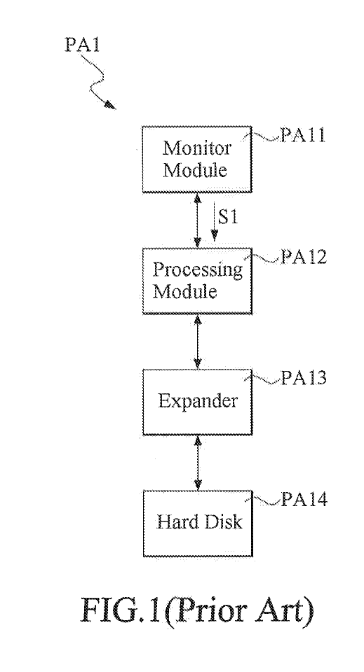

FIG. 2 is a schematic block view of a preferred embodiment of the server system for monitoring working information in accordance with the present invention; and

FIG. 3 demonstrates the display of the first real-time working information and the second real-time working information on the monitor module of FIG. 2.

### DESCRIPTION OF THE PREFERRED EMBODIMENT

The invention disclosed herein is directed to a server system for monitoring working information. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

For various combinations with slight changes can be organized to serve as the embodiments for the server system for monitoring working information of the present invention, only the preferred embodiment is provided in this closure, and all the other variations are omitted herein.

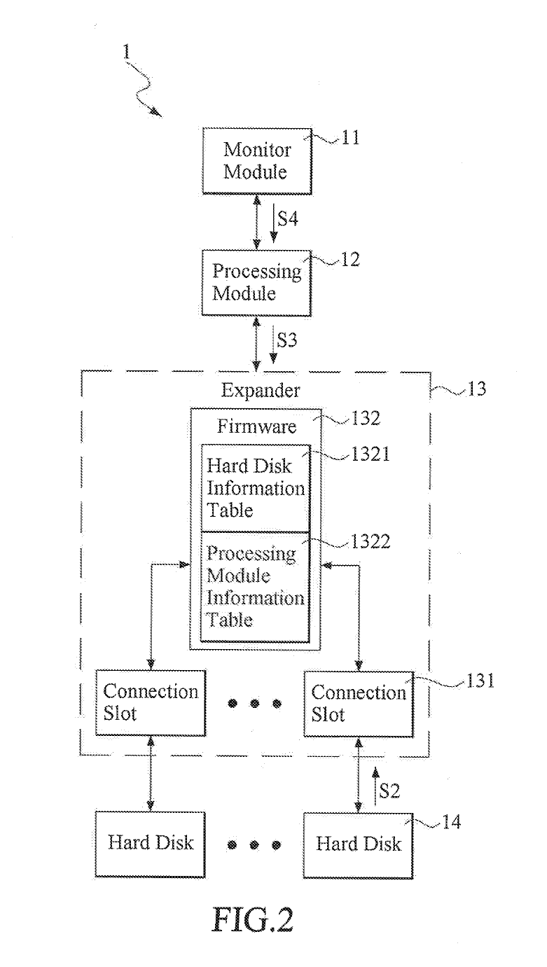

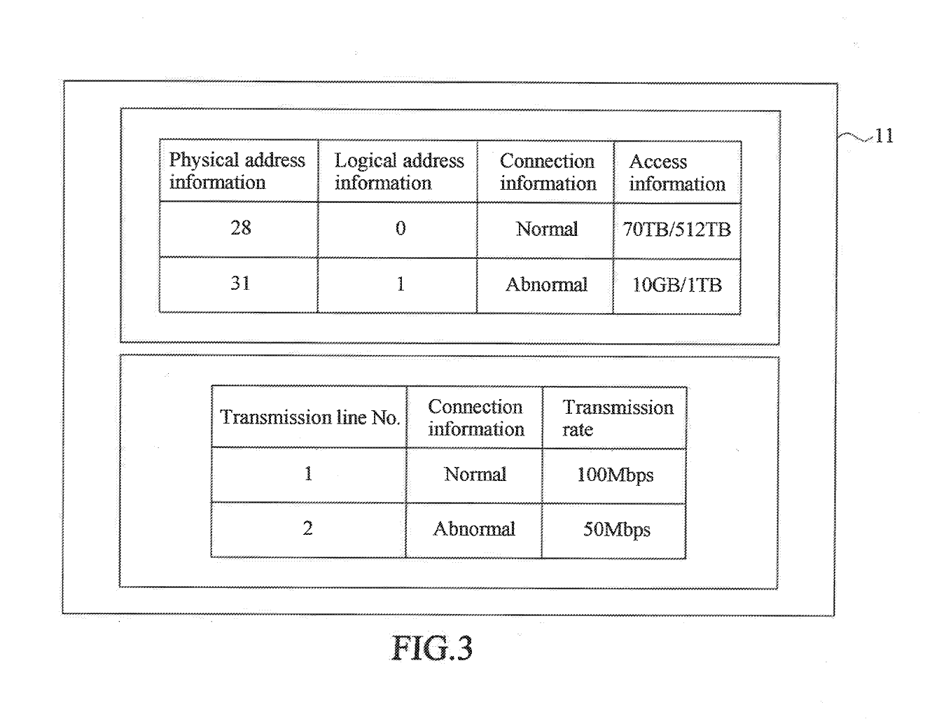

Refer now to FIG. 2 and FIG. 3, in which FIG. 2 is a schematic block view of a preferred embodiment of the server system for monitoring working information in accordance with the present invention, and FIG. 3 demonstrates the display of the first real-time working information and the second real-time working information on the monitor module of FIG. 2. As shown, the server system for monitoring working information 1 includes a monitor module 11, a processing module 12, an expander 13 and a plurality of hard disks 14 (one shown in the figure).

The monitor module 11 is general a computer apparatus or an SCSI enclosure service (SES) module. The processing module 12 electrically coupled with the monitor module 11 is general, but not limited to, a serial attached SCSI (SAS) expansion card.

The expander 13 is electrically coupled with the processing module 12 via the serial attached SCSI (SAS) interface. In this embodiment, the expander 13 and the processing module 12 can be connected via a plurality of transmission lines (cable lines for example, but not shown in the figure). In particular, these transmission lines [symbol] are to perform data transmission in accordance with the SAS transmission protocol. In addition, the expander 13 can be an SAS expander including a plurality of connection slots 131 and a firmware 132 electrically coupled with the connection slots 131.

The hard disks 14 are electrically connected to the expander 13 through electrically coupling the corresponding connection slots 131. In the present invention, the hard disk 14 can be a hard disk for the SCSI interface, while, in other embodiments, the hard disk can be hard disk for any type of transmission interface.

In this embodiment, the hard disk 14 is defined with a first real-time working information, which is one of a physical address information, a logical address information, a connection information and an access information. For example, after the hard disk 14 is plugged into one of these connection slots 131, corresponding physical address information (for example, the number of the connection slot 131 at the expander 13), logical address information, connection information (for example, the information of no connection), and access information (for example, the remaining memory to be written) would be generated. Then, the hard disk 14 would forward the first real-time working information to the expander 13 via a real-time hard disks information signal S2, such that the expander 13 would store the first real-time working information into the firmware 132. Thereby, the hard disk information table 1321 would be implemented. The hard disk information table 1321 can be (but not limited to) typically shown as follows.

TABLE 1

| Physical | Logical | | |
|---|---|---|---|
| address | address | Connection | Access |
| information | information | information | information |
| 28 | 0 | Normal | 70 TB/512 TB |
| 31 | 1 | Abnormal | 10 GB/1 TB |

In addition, the processing module 12 has a second real-time working information. This second real-time working information is a connection information telling that the processing module 12 and the expander 13 are electrically coupled through the SAS interface. The connection information can be a transmission rate. Further, for the processing module 12 is connected to the expander 13 through a plurality of transmission lines, thus each connection state and each transmission rate of the individual transmission line would be fed back to the user. Hence, the processing module 12 forwards the second real-time working information to the expander 13 via a real-time processing information signal S3, such that the expander 13 can store the second real-time working information into the firmware 132. Therefore, the processing module information table 1322 can be implemented. The processing module information table 1322 can be (but not limited to) typically shown as follows.

TABLE 2

| Transmission | Connection | |
|---|---|---|
| line No. | information | Transmission rate |
| 1 | Normal | 100 Mbps |
| 2 | Abnormal | 50 Mbps |

In this embodiment, as the user wants to access the real-time working information of the processing module 12 and the hard disks 14, the monitor module 11 should be triggered to send a monitoring signal S4 to the expander 13. Typically, an operational application software can be used to trigger the monitor module 11. Upon such arrangement, the first real-time working information and the second real-time working information stored in the firmware 132 can be captured. In this embodiment, by referring to the aforesaid hard disk information table 1321 and the processing module information table 1322, the first real-time working information of the hard disk 14 and the second real-time working information of the processing module 12 can be captured. In addition, after the user captures the first real-time working information and the second real-time working information, the monitor module 11 can display simultaneously both Table 1 and Table 2 so as to have the user aware of the connection states of the processing module 12 and the expander 13 and the availability of the individual hard disks 14.

In addition, in other embodiments, the firmware 132 having the storage of the hard disk information table 1321 can further include the information of the connection slots available to receive the hard disks 14. Thereupon, the user can understand easily the usage of the hard disks, and thus the application convenience is obvious.

In summary, by providing the server system for monitoring working information of the present invention, for the user can directly trigger the monitor module to capture the real-time working information of the processing module and the hard disks stored in the expander, thus no more report of the working information from the processing module is required, and definitely the capturing efficiency of the information can be upgraded and the prior problem in incompatibility can be resolved.

While the present invention has been particularly shown and described with reference to a preferred embodiment, it will be understood by those skilled in the art that various changes in form and detail may be without departing from the spirit and scope of the present invention.

What is claimed is:

1. A server system for monitoring working information, comprising:
a plurality of hard disks, each of the hard disks having a first real-time working information and being provided to transmit a real-time hard disk information signal including the first real-time working information;
a processing module, having a second real-time working information, being provided to transmit a real-time processing information signal including the second real-time working information; and
an expander, having a firmware, being electrically coupled between the hard disks and the processing module, being to receive the real-time hard disk information signal and the real-time processing information signal so as to have the first real-time working information and the second real-time working information to be stored into the firmware;
wherein a monitor module electrically coupling the processing module transmits a monitoring signal to the expander so as to capture the first real-time working information and the second real-time working information stored in the firmware.

2. The server system for monitoring working information of claim 1, wherein the first real-time working information is at least one of a physical address information, a logical address information, a connection information and an access information.

3. The server system for monitoring working information of claim 2, wherein, after the expander receives the first real-time working information, the first real-time working information is stored into the firmware so as to establish a hard disk information table, and the hard disk information table includes at least one correlation among the physical address information, the logical address information, the connection information and the access information.

4. The server system for monitoring working information of claim 1, wherein the processing module and the expander are electrically coupled through a serial attached SCSI (SAS) interface.

5. The server system for monitoring working information of claim 4, wherein the second real-time working information is connection information of the processing module coupling electrically the expander via the serial attached SCSI (SAS) interface.

6. The server system for monitoring working information of claim 5, wherein the connection information is a transmission rate.

7. The server system for monitoring working information of claim 5, wherein, after the expander receives the second real-time working information, the second real-time working information is stored into the firmware so as to establish a processing module information table, and the processing module information table lists a corresponding relationship between a number of a transmission line and the connection information.

8. The server system for monitoring working information of claim 1, wherein the monitor module is an SCSI enclosure service (SES) module.
